(19) United States
(12) Patent Application Publication
(10) Pub. No.: US 2024/0286327 A1
(43) Pub. Date: Aug. 29, 2024

(54) LEADING EDGE PROTECTION SHIELD

(71) Applicant: VESTAS WIND SYSTEMS A/S, Aarhus N (DK)

(72) Inventor: Jonathan SMITH, Burridge (GB)

(21) Appl. No.: 18/571,685

(22) PCT Filed: Jun. 16, 2022
(86) PCT No.: PCT/DK2022/050128

§ 371 Date: Dec. 18, 2023

(30) Foreign Application Priority Data
Jun. 18, 2021 (DK) PA202170309

(51) Int. Cl. B29C 45/14; B29C 45/26; B29C 45/67; B29K 63/00; B29K 75/00; B29K 83/00; B29L 31/08; F03D 1/06

(52) U.S. Cl. CPC B29C 45/14336; B29C 45/26; B29C 45/2608; B29C 45/67; B29K 2063/00; B29K 2075/00; B29K 2083/00; B29L 2031/085; F03D 1/0688; F05B 2240/303

(57) ABSTRACT

In a first aspect of the invention there is provided a method of forming a leading edge protection shield on a wind turbine blade shell. The method comprises providing at least a portion of a wind turbine blade shell comprising a windward surface, a leeward surface, and a leading edge, providing a leading edge mould comprising a concave curved mould surface and arranging the mould over the leading edge of the blade shell such that a generally C-shaped cavity is defined between the blade shell and the mould surface. The method further comprises clamping the mould to the windward surface and/or to the leeward surface of the blade shell using a clamping arrangement spaced from the leading edge in a chordwise direction. The method further comprises providing an edge scaling arrangement positioned between the leading edge and the clamping arrangement in the chordwise direction, and forming a seal between the mould surface and the windward and leeward surfaces of the blade shell using the edge sealing arrangement to define windward and leeward edges of the C-shaped cavity. The mould surface is substantially tangential to the windward and leeward surfaces at the windward and leeward edges such that the C-shaped cavity tapers in thickness towards the windward and leeward edges of the C-shaped cavity. The method further comprises supplying polymer to the C-shaped cavity to form a leading edge protection shield on the blade shell.

### TECHNICAL FIELD

The present invention relates generally to leading edge protection of wind turbine blades, and more specifically to a method of applying a leading edge protection shield to a wind turbine blade.

### BACKGROUND

Wind turbines frequently experience severe weather conditions due to their remote location, particularly in offshore wind installations. Collisions between a wind turbine blade and airborne particles such as rain or hail cause erosion of the blade's surface. Such erosion reduces the aerodynamic performance of the blade, thereby adversely affecting the annual energy production (AEP) of the wind turbine. As blade lengths increase to capture more energy from the wind, the tip velocity of such blades also increases. At high tip velocities, erosion of the blade surface, particularly at a leading edge of the blade, is exacerbated by the increased impact energy in collisions with airborne particles.

A number of solutions for alleviating leading edge erosion have previously been proposed, including applying protective tape or layers of protective paint. However, such solutions can be difficult and time consuming to apply accurately, are prone to contamination during the application process, and may not sufficiently dissipate the impact energy from collisions with airborne particles. As such it has been found that the application of such leading edge protection methods may not be sufficiently robust and/or that such leading edge protection methods may not have the requisite longevity.

A more promising proposal is to apply separately manufactured add-on devices to the leading edge of a blade. For example, leading edge shields/shells formed of metal or polymer have previously been proposed. However, whilst it has been found that such leading edge shields do provide improved protection, such shields may delaminate from the wind turbine blade in an early stage of their projected use-period. Adding such devices to the leading edge of a wind turbine blade can also negatively affect the aerodynamic performance of the blade. Increased drag is caused in particular by the step height between the blade surface and edges of the shield. It is impossible to reduce this step height to an ideal zero thickness using known polymer shell add-on devices.

It is against this background that the present invention has been developed.

### SUMMARY OF INVENTION

In a first aspect of the invention there is provided a method of forming a leading edge protection shield on a wind turbine blade shell. The method comprises providing at least a portion of a wind turbine blade shell comprising a windward surface, a leeward surface, and a leading edge, providing a leading edge mould comprising a concave curved mould surface and arranging the mould over the leading edge of the blade shell such that a generally C-shaped cavity is defined between the blade shell and the mould surface. The method further comprises clamping the mould to the windward surface and/or to the leeward surface of the blade shell using a clamping arrangement spaced from the leading edge in a chordwise direction. The method further comprises providing an edge sealing arrangement positioned between the leading edge and the clamping arrangement in the chordwise direction, and forming a seal between the mould surface and the windward and leeward surfaces of the blade shell using the edge sealing arrangement to define windward and leeward edges of the C-shaped cavity. The mould surface is substantially tangential to the windward and leeward surfaces at the windward and leeward edges such that the C-shaped cavity tapers in thickness towards the windward and leeward edges of the C-shaped cavity. The method further comprises supplying polymer to the C-shaped cavity to form a leading edge protection shield on the blade shell. The polymer is preferably supplied after forming of the seal using the edge sealing arrangement. This ensures that no or substantially no air or polymer is removed from the C-shaped cavity when polymer is supplied and thereby a sharp and very shallow edge of the leading edge protection shield is formed with no or minimum post work required after moulding.

The chordwise direction may be defined as a direction that is parallel to a line between the leading edge and a trailing edge of the wind turbine blade shell. The thickness of the C-shaped cavity may be defined as a perpendicular distance from the mould surface to the blade shell.

The C-shaped cavity preferably comprises a maximum thickness at or near the leading edge. The C-shaped cavity preferably comprises a minimum thickness at the windward edge and/or leeward edge of the cavity. Most preferably, the C-shaped cavity comprises minimum thicknesses at both the windward and leeward edges of the cavity, the thickness of the cavity approaching zero at both edges, and the mould surface approaching tangential alignment with the windward and leeward surfaces towards the windward and leeward edges.

The method preferably comprises forming a seal between the mould surface and the windward and leeward surfaces of the blade shell using the edge sealing arrangement first, before subsequently clamping the mould to the windward surface and/or leeward surface of the blade shell.

The clamping arrangement may comprise a first sealed volume defined between the mould and the windward and/or leeward surfaces of the blade shell. The step of clamping the mould to the windward surface and/or the leeward surface may comprise evacuating the first sealed volume.

The first sealed volume is preferably separate to the C-shaped cavity. The first sealed volume is preferably spaced apart from the C-shaped cavity in the chordwise direction.

The clamping arrangement preferably comprises a vacuum clamp. The vacuum clamp may have a pair of mutually spaced first seals. The first sealed volume may be defined at least in part by sealing the pair of first seals against the windward and/or leeward surface of the blade shell.

The method may comprise clamping the mould to both the windward surface and the leeward surface of the blade shell using the clamping arrangement.

The edge sealing arrangement may comprise a second sealed volume defined between the mould and the windward and leeward surfaces of the blade shell. The method may further comprise evacuating the second sealed volume.

The second sealed volume is preferably separate to the C-shaped cavity and separate to the first sealed volume. The second sealed volume is preferably located adjacent to the C-shaped cavity. The second sealed volume is preferably located between the C-shaped cavity and the first sealed volume.

The edge sealing arrangement preferably comprises a pair of mutually spaced second seals. The second sealed volume may be defined at least in part by sealing the pair of second seals against the windward and leeward surface of the blade shell.

Evacuating the second sealed volume may cause the mould surface to the move into tangential alignment with the windward and leeward surfaces at the windward and leeward edges of the C-shaped cavity. The mould may be flexible such that evacuating the second sealed volume pulls the mould surface towards the windward and leeward surfaces of the blade shell to create the tapered edges of the C-shaped cavity. The flexibility of the mould may enable the mould to conform to the shape of the blade shell when forming the seal using the edge sealing arrangement.

The edge sealing arrangement preferably comprises an abutment surface. The abutment surface may be substantially co-planar with the mould surface. Evacuating the second sealed volume preferably causes the abutment surface to be brought into abutment with the windward and leeward surface of the blade shell.

The method may further comprise supplying the polymer to the C-shaped cavity under positive pressure. The method may comprise evacuating the C-shaped cavity prior to supplying the polymer. The polymer is preferably supplied at a pressure of a lower magnitude than the pressure used to evacuate the second sealed volume.

The mould may comprise a plurality of spacing protrusions extending inwardly from the mould surface. The spacing protrusions may engage the blade shell to define a thickness of the C-shaped cavity. The spacing protrusions may be conical protrusions tapering to a point configured for arrangement against the blade shell.

The method may comprise filling the C-shaped cavity with polymer in a single shot to form the leading edge protection shield as a single layer of polymer on the blade shell. The polymer is preferably formed directly onto the blade shell. The polymer preferably comprises polyurethane. Alternatively, the polymer may comprise a multi-part composition, such as two-part epoxy resin. Alternatively, the polymer may comprise silicon and/or rubber.

The method may further comprise applying heat to the polymer in the cavity during a curing process.

The method may further comprise removing air from the C-shaped cavity via one or more air outlets in fluid communication with the C-shaped cavity. It is preferred that the air outlets are not in fluid communication with the first sealed volume or the second sealed volume so air may be removed from the C-shaped cavity and polymer may be supplied to the C-shaped cavity without the air or polymer from the C-shaped cavity entering the first sealed volume or the second sealed volume.

In another aspect of the invention there is provided a mould for forming a leading edge protection shield on a wind turbine blade shell. The mould comprises a concave curved mould surface for arranging over a leading edge of a blade shell to define a substantially C-shaped cavity, and a clamping arrangement for clamping the mould to a windward surface and/or a leeward surface of the blade shell. The mould further comprises an edge sealing arrangement located between the mould surface and the clamping arrangement, the edge sealing arrangement being configured for sealing the mould surface to the blade shell at windward and leeward edges of the C-shaped cavity such that the C-shaped cavity tapers in thickness towards said windward and leeward edges.

The clamping arrangement may comprise a vacuum clamp having a pair of mutually spaced first seals configured to seal against the windward and/or leeward surface of the blade shell to define a first sealed volume, and a first vacuum outlet for withdrawing air from the first sealed volume.

The edge sealing arrangement may comprise a pair of mutually spaced second seals configured to seal against the windward and leeward surface of the blade shell to define a second sealed volume. The edge sealing arrangement may further comprise a second vacuum outlet for withdrawing air from the second sealed volume. It is preferred that the second sealed volume is separated from the C-shaped cavity so that when air is withdrawn from the second sealed volume to activate the second seals, then air and polymer cannot move from the C-shaped cavity to the second sealed volume, so second seal creates well-defined edges of the C-shaped cavity.

The second seals may be compressible. The second seals may be sponge seals. The second seals may comprise a compressible sponge core surrounded by an elastomer skin. In other examples the second seals may comprise a hollow or gas-filled core surrounded by an elastomer skin.

The edge sealing arrangement may further comprise a seal carrier that retains the second seals. Preferably the seal carrier is formed of an elastomer material. The second seals may protrude from the seal carrier when uncompressed. The second seals may be substantially fully contained within the seal carrier when compressed.

The edge sealing arrangement may comprise an abutment surface. The abutment surface may be defined between the pair of mutually spaced second seals. The abutment surface may be substantially co-planar with the mould surface. The seal carrier may define the abutment surface.

The second seals may comprise a substantially circular cross-sectional profile. Preferably a segment of the cross-sectional profile protrudes from the seal carrier when uncompressed. Preferably, a segment of the cross-sectional profile protrudes beyond the mould surface and/or abutment surface.

The mould may be flexible such that it may conform to the shape of the blade shell. The whole mould surface may be flexible. In some examples, the mould surface may comprise one or more flexible portions. The mould surface may comprise a substantially flexible windward edge portion adjacent to the windward edge of the cavity. The mould surface may comprise a substantially flexible leeward edge portion adjacent to the leeward edge of the cavity. The mould may comprise a substantially rigid central portion of the mould surface configured for arrangement with the leading edge of the blade shell. The substantially rigid central portion of the mould surface may be configured to ensure that the mould forms a leading edge protection shield is with an optimized aerodynamic profile. As such, the substantially rigid central portion of the mould surface may comprise an optimised aerodynamic profile.

The mould may comprise one or more air outlets in fluid communication with the C-shaped cavity. It is preferred that the air outlets are not in fluid communication with the first sealed volume or the second sealed volume so air may be removed from the C-shaped cavity and polymer may be supplied to the C-shaped cavity without the air or polymer from the C-shaped cavity entering the first sealed volume or the second sealed volume.

The mould may be configured for use in a method as described herein.

The mould surface may comprise one or more recesses configured to integrally form one or more aerodynamic features with the leading edge protection shield such that the aerodynamic features extend from an outer surface of the shield.

The mould may comprise heating apparatus configured to apply heat to the C-shaped cavity via the mould surface. The mould may be insulated to conserve energy released by an exothermic curing reaction.

### BRIEF DESCRIPTION OF FIGURES

Embodiments of the present invention will now be described by way of non-limiting example only, with reference to the accompanying figures, in which:

FIG. 1 is a schematic cross-sectional view of a wind turbine blade shell comprising a leading edge protection shield in accordance with an example of the prior art;

FIG. 2 is a schematic cross-sectional view of the blade shell and a mould configured to apply a leading edge protection shield to the blade shell in accordance with an example of the present invention;

FIG. 3 is an enlarged view of the arrangement of the mould on the blade shell;

FIG. 4 shows an edge sealing arrangement configured to form a seal between the mould and the blade shell;

FIG. 5a is a schematic cross-sectional view showing a C-shaped mould cavity filled with polymer;

FIG. 5b is a schematic cross-sectional view of a leading edge protection shield formed on the wind turbine blade shell in accordance with an example of the present invention;

FIG. 6a is a schematic cross-sectional view of a blade shell and a mould configured to apply a leading edge protection shield comprising an aerodynamic element to the blade shell; and

FIG. 6b is a schematic cross-sectional view of a leading edge protection shield comprising an aerodynamic element applied to the wind turbine blade shell.

### DETAILED DESCRIPTION

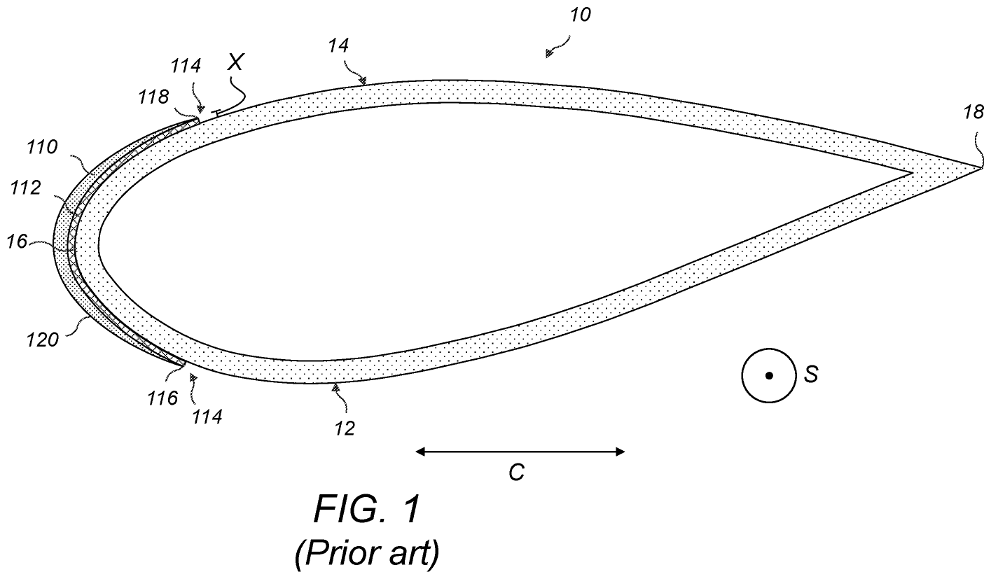

FIG. 1 shows a schematic cross-sectional view of a portion of a wind turbine blade shell 10. In some examples, the blade shell 10 may be formed of a composite material such as fibre reinforced polymer and may comprise a substantially hollow construction. The blade shell 10 preferably comprises an aerodynamic profile to extract energy from wind incident on the blade in use. As such, the blade shell 10 comprises a windward surface 12 and a leeward surface 14 which meet at a leading edge 16 and a trailing edge 18 of the blade shell 10. The blade shell 10 extends longitudinally in a spanwise direction S substantially perpendicular to the plane of the page in FIG. 1. A chordwise direction C is substantially perpendicular to the spanwise direction S, and extends substantially parallel to a line between the leading edge 16 and trailing edge 18 of the blade shell 10.

As previously described by way of background, the leading edge 16 of the blade shell 10 is susceptible to erosion and damage from collisions with airborne particles in use. As such, the blade shell 10 may be fitted with a leading edge protection shield 110. The blade shell 10 shown in FIG. 1 is fitted with an add-on leading edge protection shield 110 in accordance with an example of the prior art.

Add-on leading edge protection shields 110 or shells of the prior art are typically attached to the blade shell 10 using adhesive 112. As shown in FIG. 1, a step 114 is formed at windward and leeward edges 116, 118 of the prior art shield 110 between an outer surface 120 of the shield 110 and the windward and leeward surfaces 12, 14 of the blade shell 10. Even if the thickness of the add-on device tapers to an extremely thin edge 116, 118, attaching the prior art shield 110 to the blade shell 10 requires adhesive 112 between the shield 110 and the blade shell 10. As such, it is not possible to attach a prior art add-on device 110 to the leading edge 16 of the blade shell 10 without forming a step 114 between the blade shell 10 and the add-on device 110. The step 114 has a height X at least equal to the thickness of the adhesive 112. The step 114 disturbs the airflow over the aerodynamic profile of the blade shell 10 and increases drag, thereby reducing the aerodynamic performance of the blade.

A further issue with this approach is that, in a best-case scenario wherein the shield 110 tapers to an extreme thinness at the edges 116, 118, these thin edges, combined with the inherent elasticity of the shield material and the varying aerodynamic profile of the blade shell 10, make it very difficult to attach the shield 110 to the blade shell without forming wrinkles (not shown) at the thin edges 116, 118 of the shield 110. Such wrinkles also disrupt the airflow over the shield 110 and blade shell 10 in use, and are therefore also detrimental to the aerodynamic performance of the wind turbine blade.

The present invention facilitates the formation of a leading edge protection shield 20 on a wind turbine blade shell 10 which overcomes the aerodynamic drawbacks and adhesion difficulties associated with add-on protection shields 110 of the prior art as will now be described with reference to the remaining figures. The blade shell 10 in the following examples is substantially identical to the blade shell 10 described with reference to FIG. 1 and identical features of the blade shell 10 will not be described again in the interest of conciseness.

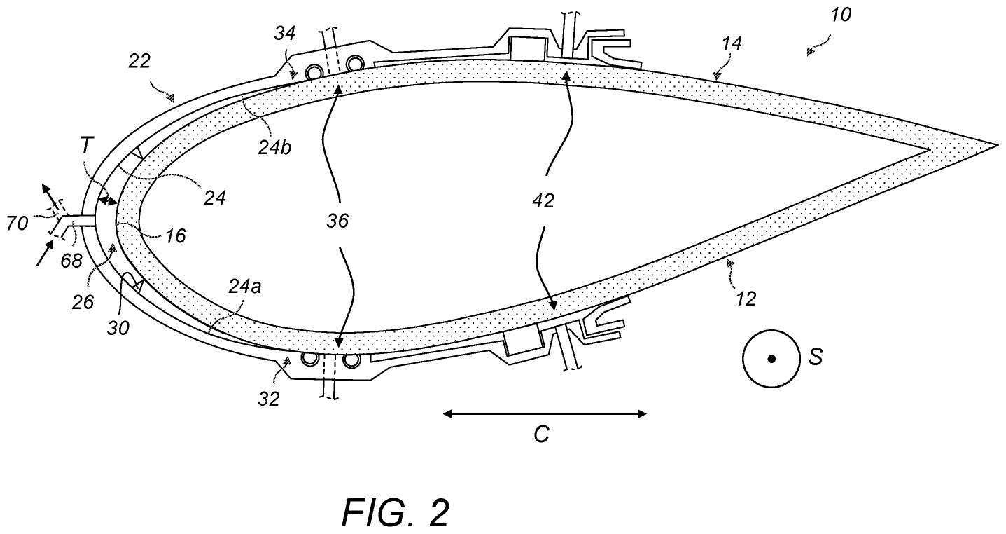

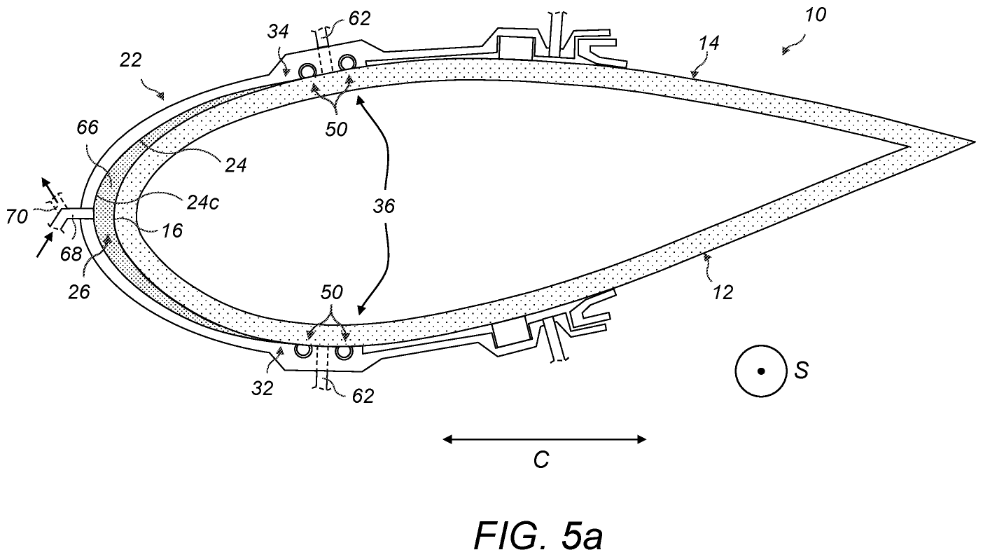

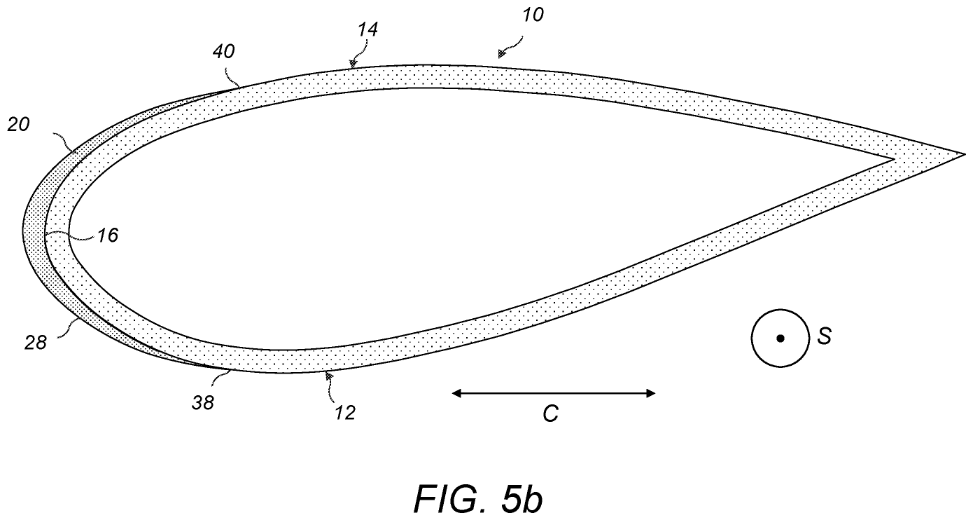

Referring initially to FIG. 2, a leading edge mould 22 in accordance with an example of the present invention may be used to form a leading edge protection shield 20 (see FIG. 5b) on the blade shell 10. The mould 22 comprises a mould surface 24 which, when arranged over the leading edge 16 of the blade shell 10, defines a generally C-shaped cavity 26 between the blade shell 10 and the mould surface 24. As such, when arranged with the blade shell 10, the mould surface 24 is concave curved and is substantially wrapped around the blade shell 10 over the leading edge 16. The mould surface 24 is preferably substantially smooth to form a smooth outer surface 28 (see FIG. 5b) on the leading edge protection shield 20.

The mould 22 may further comprise a plurality of spacing protrusions 30 extending inwardly from the mould surface 24 to separate the mould surface 24 from the blade shell 10 by a predetermined distance. The spacing protrusions 30 engage the blade shell 10 to define a thickness T of the C-shaped cavity 26 when the mould 22 is arranged with the blade shell 10. The C-shaped cavity 26 preferably has a maximum thickness at or near to the leading edge 16 of the blade shell 10 to form a leading edge protection shield 20 having a maximum thickness at or near to the leading edge 16. Direct collisions between airborne particles and the blade shell 10 at the leading edge 16 typically have the greatest impact energies. It is therefore advantageous to form a leading edge protection shield 20 with a maximum thickness at the leading edge 16 to absorb the impact energy of such collisions most effectively.

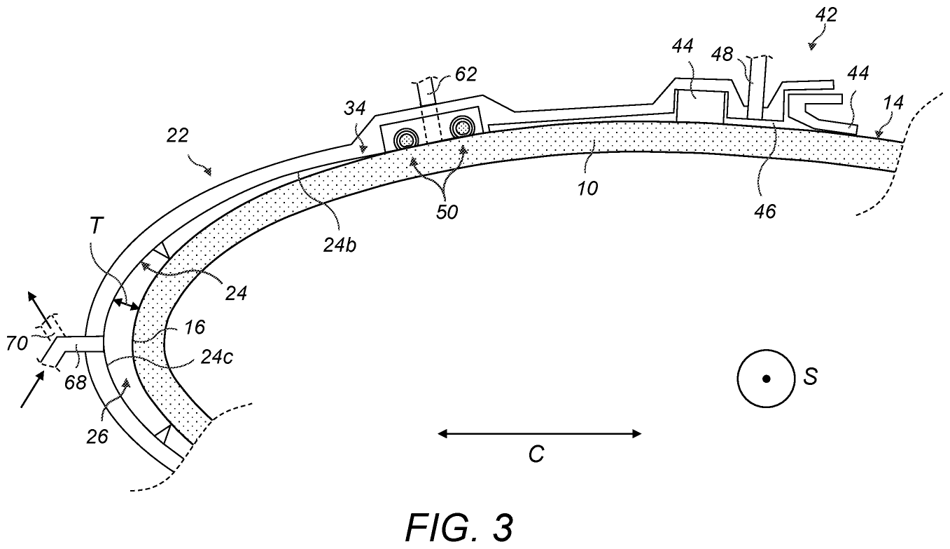

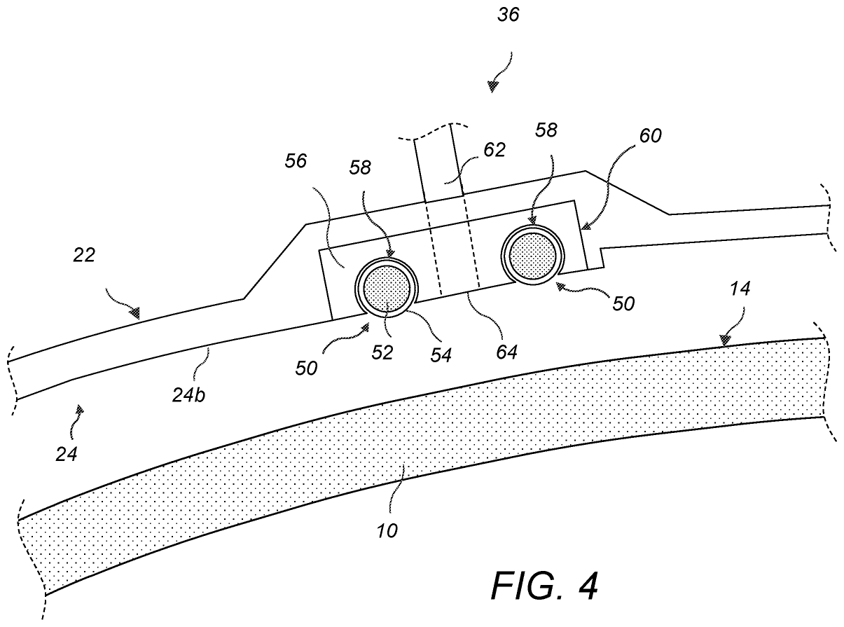

A seal is formed between the mould surface 24 and the windward and leeward surfaces 12, 14 of the blade shell 10 to define windward and leeward edges 32, 34 of the C-shaped cavity 26. The mould surface 24 is sealed to the windward and leeward surfaces 12, 14 using an edge sealing arrangement 36. The edge sealing arrangement 36 will be described later in more detail with reference to FIGS. 3 and 4, however, as shown in FIG. 2, the mould 22 of the present invention advantageously facilitates a substantially tangential arrangement of the mould surface 24 with the windward and leeward surfaces 12, 14 of the blade shell 10 at the windward and leeward edges 32, 34 of the cavity 26.

The tangential arrangement of the mould surface 24 with the windward and leeward surfaces 12, 14 at the windward and leeward edges 32, 34 of the C-shaped cavity 26 results in a cavity that tapers in thickness T towards its windward and leeward edges 32, 34. As such, a leading edge protection shield 20 formed by the mould 22 similarly tapers in thickness towards its windward and leeward edges 38, 40 (see FIG. 5b). In particular the tangential arrangement of the mould surface 24 with the blade shell 10 at the windward and leeward edges 32, 34 advantageously minimises or substantially avoids the formation of any step between the outer surface 28 of the leading edge protection shield 20 and the blade shell 10 (as shown most clearly in FIG. 5b).

A clamping arrangement 42 is used to clamp the mould 22 to the blade shell 10 and fix it in position during moulding of the leading edge protection shield 20 on the blade shell 10. The clamping arrangement 42 is spaced from the leading edge 16 in the chordwise direction C such that the edge sealing arrangement 36 is positioned between the leading edge 16 and the clamping arrangement 42. In preferred examples, the clamping arrangement 42 may comprise a vacuum clamp as will be described later in more detail with reference to FIG. 3.

The clamping arrangement 42 is configured primarily for fixing the mould 22 in position on the blade shell 10. Preferably the clamping arrangement 42 is completely separate from the edge sealing arrangement 36 used to form a seal between the mould surface 24 and the blade shell 10. The provision of two separate arrangements 36, 42 for these separate functions means that the clamping arrangement 42 and edge sealing arrangement 36 can each be optimised for their respective purposes.

For example, the clamping arrangement 42 may comprise a heavy-duty vacuum clamp arrangement that is optimised for fixing a heavy mould 22 in place on the blade shell 10, but which may not necessarily be optimised for creating a high tolerance seal between the mould surface 24 and the blade shell 10 to form a cavity 26 that tapers to thin edges 32, 34. Further, the edge sealing arrangement 36 is not required to bear the weight of the mould 22 to fix the mould 22 in position, and may therefore be optimised instead to help form a tapering C-shaped cavity 26 where the mould surface 24 is substantially tangential to the windward and leeward surfaces 12, 14 at the windward and leeward edges 32, 34. The provision of separate arrangements 36, 42 for sealing the cavity 26 and for attaching the mould 22 therefore facilitates the definition of an optimised C-shaped cavity 26.

The configuration of the clamping arrangement 42 may vary dependent on the requirements of a specific application and the orientation of the blade shell 10 when forming the shield 20 thereon. For example, it may be sufficient to clamp the mould 22 to one of the windward or leeward surfaces 12, 14 of the blade shell 10 if using the mould 22 to form a leading edge protection shield 20 on a blade shell 10 in a blade manufacturing facility. Alternatively, in other examples the clamping arrangement 42 may be configured to clamp the mould 22 to both the windward and leeward surfaces 12, 14 of the blade shell 10, as shown in FIG. 2 for example. Such a configuration may be advantageous when a stronger or more secure attachment of the mould 22 is required, for example if using the mould 22 to form a leading edge protection shield 20 on a wind turbine blade shell 10 that is already attached to a wind turbine in the field.

With reference to the enlarged view in FIG. 3, the clamping arrangement 42 in some examples may comprise a vacuum clamp having one or more first seals 44. Preferably the vacuum clamp 42 comprises a pair of mutually spaced first seals 44 configured to seal against the windward and/or leeward surface 12, 14 of the blade shell 10 to define a first sealed volume 46. Air is withdrawn from the first sealed volume 46 to clamp the mould 22 to the blade shell 10. As such, the clamping arrangement 42 may comprise a first vacuum outlet 48 for withdrawing air from the first sealed volume 46.

Withdrawing air from the first sealed volume 46 results in a negative pressure differential between the first sealed volume 46 and atmospheric pressure outside of the mould 22 by means of which the mould 22 is attached to the blade shell 10. Preferably, the first seals 44 are heavy-duty seals capable of withstanding a high pressure differential to keep the mould 22 fixed to the blade shell 10 using vacuum pressure. The vacuum clamp 42 facilitates simple, fast attachment and rearrangement of the mould 22 on the blade shell 10 without complex fixturing or fasteners. This ensures that the mould 22 can be positioned accurately for each application, ensuring that each leading edge protection shield 20 is accurately formed to a high tolerance and improving the repeatability of the process in comparison to methods of the prior art.

Referring now to both FIGS. 3 and 4, the edge sealing arrangement 36 in some preferred examples may comprise a pair of mutually spaced second seals 50. The second seals 50 are configured to seal against the windward and leeward surfaces 12, 14 of the blade shell 10. In preferred examples, the second seals 50 are compressible seals which deform when arranged against the windward and leeward surfaces 12, 14 of the blade shell 10. The second seals 50 may be sponge seals for example, comprising a compressible foam core 52 surrounded by an elastomer 54, as shown most clearly in FIG. 4. Sponge seals 50 advantageously deform in on themselves when compressed, thereby being flattened and presenting an increased surface area for sealing, as can be seen in a comparison between FIG. 4 (uncompressed) and FIG. 3 (compressed).

The second seals 50 may be retained in a seal carrier 56 in some examples. For example, channels 58 retaining the second seals 50 may be provided in a seal carrier 56 rather than directly in the mould 22. Channels 58 for retaining the second seals 50 may be complex and difficult to manufacture in the mould 22, whereas a simple channel 60 for a seal carrier 56 may be more cost-effective to manufacture in the mould 22. The seal carrier 56 may be formed of a polymer material, preferably an elastomer, and may be moulded or extruded to form the more complex seal retaining channels 58.

Sealing the second seals 50 against the windward and leeward surfaces 12, 14 of the blade shell 10 preferably defines a second sealed volume. For example, the second sealed volume may be defined at least in part by the mould 22, the second seals 50, and the windward and leeward surfaces 12, 14 of the blade shell 10. After forming the second sealed volume, air may be withdrawn, i.e. evacuated, from the second sealed volume. As such, the edge sealing arrangement 36 may comprise one or more second vacuum outlet 62 via which air is withdrawn from the second sealed volume. The second sealed volume is preferably separate to both the first sealed volume 46 and the C-shaped cavity 26. Notably, the second seals 50 help to isolate the second sealed volume from the C-shaped cavity 26 which is adjacent to the edge sealing arrangement 36, so air and polymer cannot move from the C-shaped cavity to the second sealed volume during supply of polymer to the C-shaped cavity. This allows for the creation of well-defined edges of the leading edge protection shield with no or minimum post work required after moulding.

In particularly advantageous examples, withdrawing air from the second sealed volume may cause the mould surface 24 to move into tangential alignment with the windward and leeward surfaces 12, 14 of the blade shell 10 at the windward and leeward edges 32, 34 of the C-shaped cavity 26. As such, at least part of the mould surface 24 is preferably flexible such that it may conform to the shape of the blade shell 10. For example, at least a windward edge portion 24a and a leeward edge portion 24b of the mould surface 24 may be substantially flexible to conform to the shape of the blade shell 10 and be brought into tangential alignment with the windward and leeward surfaces 12, 14 when air is withdrawn from the second sealed volume. In such preferred examples the flexibility of the mould surface 24 advantageously facilitates a simple tangential alignment of the mould surface 24 with the blade shell surfaces 12, 14 at the windward and leeward edges 32, 34 of the C-shaped cavity 26. This may allow for forming a very shallow edge of the leading edge protection shield with no or minimum post work required after moulding.

In some examples, a substantially central portion 24c of the mould surface 24, i.e, a portion configured for arrangement directly over the leading edge 16 of the blade shell 10, may be substantially rigid. Such a rigid central portion 24c may not deform when the mould 22 is arranged with the blade shell 10, thereby helping to form a leading edge protection shield 20 with an aerodynamically optimised profile. Such a rigid central portion 24c may be particularly advantageous in examples wherein the mould 22 comprises spacing protrusions 30 in order to ensure that the mould surface 24 maintains an optimum aerodynamic profile around the spacing protrusions 30. Use of a mould with a substantially rigid portion allows for obtaining the optimum aerodynamic profile irrespective of imperfections in the blade surface 10, for example originating from wear of the blade by erosion (when retrofitting) or imperfections from misalignments or other imperfections in the blade shell originating from blade manufacturing. It should be observed that the method according to the invention thereby allows for a more tolerant method of providing a blade having a perfect aerodynamic profile after application of a leading edge protection shell.

Referring still to FIGS. 3 and 4, the second seals 50 preferably protrude from the seal carrier 56, or from the seal retaining channels 58, when uncompressed (see FIG. 4) in order to initially form a seal against the windward and leeward surfaces 12, 14. This initial sealing of the second seals 50 against the blade shell 10 preferably forms the second sealed volume (not shown). When the second sealed volume is evacuated, as shown in FIG. 3 for example, the second seals 50 are compressed in their seal retaining channels 58. When compressed, the second seals 50 are preferably substantially fully contained within the seal carrier 56, or within the seal retaining channels 58, whilst still forming a seal against the windward and leeward surfaces 12, 14. The second seals 50 ensure that even if the mould surface 24 is not in direct contact with the blade shell 10 along the entire windward or leeward edge 32, 34, there remains an air-tight barrier between the C-shaped cavity 26 and the second sealed volume.

The mould 22 preferably comprises an abutment surface 64 configured to abut the windward and leeward surfaces 12, 14 of the blade shell 10 when air is withdrawn from the second sealed volume. Air is preferably withdrawn from the second sealed volume, and the second seals 50 are preferably compressed in the seal retaining channels 58, until the abutment surface 64 is brought into contact with the blade shell 10. Compressible second seals 50, such as sponge seals, are therefore particularly advantageous because they deform in on themselves completely, thereby allowing the abutment surface 64 to be brought into contact with the blade shell 10.

The abutment surface 64 is preferably substantially co-planar with the mould surface 24 at the windward and leeward edges 32, 34 of the C-shaped cavity 26. Further, the windward and leeward edge portions 24a, 24b of the mould surface 24 are preferably at least initially co-planar with the abutment surface 64. Such a configuration advantageously results in bringing the mould surface 24 into tangential alignment with the windward and leeward surfaces 12, 14 of the blade shell 10 when the abutment surface 64 is brought into contact with the blade shell 10.

The abutment surface 64 may be located between the mutually spaced second seals 50, and may define part of the second sealed volume. In some examples, as shown in FIGS. 3 and 4, the abutment surface 64 may be defined by the seal carrier 56. In such examples it is further advantageous to form the seal carrier 56 in a polymer or elastomer material to ensure that the blade shell 10 is not damaged when the abutment surface 64 is brought into abutment with the windward and leeward surfaces 12, 14. If the abutment surface 64 is located between the second seal 50 and the leading edge 16, then the abutment surface 64 is preferably closer to the second seal 50 than the leading edge 16.

After sealing the mould surface 24 to the windward and leeward surfaces 12, 14 of the blade shell 10, polymer 66 is supplied to the C-shaped cavity 26 as shown in FIG. 5a. The polymer 66 may be supplied to the C-shaped cavity 26 via one or more polymer inlet channels 68. The mould 22 preferably also comprises one or more air outlets 70 in fluid communication with the C-shaped cavity 26 such that air can be displaced from the C-shaped cavity 26 when the polymer is supplied thereto. Such air outlets 70 advantageously allow the cavity 26 to be filled with polymer 66 without displacing the mould 22 from the blade shell 10 or breaking the seal between the mould surface 24 and the blade shell 10.

Whilst the mould surface 24 is preferably brought into contact with the blade shell 10 at the windward and leeward edges 32, 34 of the C-shaped cavity 26, the second seals 50 of the edge sealing arrangement 36 further ensure that no polymer 66 can leak from the C-shaped cavity 26 into the second sealed volume. As such, the second seals 50 ensure a clean finish is achieved at the windward and leeward edges 38, 40 of the shield 20, and further ensure that no polymer 66 is introduced into the second sealed volume and particularly into the one or more second vacuum outlets 62. This allows for formation of a well-defined edge of the leading edge protection shield with no or minimum post work required after moulding.

The C-shaped cavity 26 is preferably completely filled with polymer 66. In some examples, the cavity 26 may be evacuated prior to supplying the polymer 66 in order to expedite the filling of the cavity 26 and to help ensure that the cavity 26 is thoroughly filled. Strategic placement of the or each polymer inlet channel 68 and the air outlets 70 may further aid in ensuring the C-shaped cavity 26 is thoroughly filled with polymer 66. For example, the polymer inlet 68 may be provided in a substantially central portion 24c of the mould surface 24, and the air outlets 70 may be spaced apart in the spanwise direction S and/or arranged near the periphery of the C-shaped cavity 26, such as near the windward and leeward edges 32, 34, to encourage the polymer 66 to thoroughly fill the cavity 26. Alternatively, as shown in FIG. 5a, the polymer inlet 68 and air outlets 70 may both be provided in a substantially central portion 24c of the mould surface 24 and spaced apart in the spanwise direction S to encourage the polymer 66 to flow in the spanwise direction S.

In some examples the polymer 66 may be supplied to the C-shaped cavity 26 under positive pressure to inject the polymer 66 into all extremities of the cavity 26. In such examples, the positive pressure with which the polymer 66 is injected is preferably smaller in magnitude than the vacuum pressure with which the second sealed volume is evacuated. Injecting the polymer 66 in this way ensures that the injection pressure does not displace the mould 22 from the blade shell 10 or break the seal between the mould surface 24 and the blade shell 10.

With reference now also to FIG. 5b, which shows the leading edge protection shield 20 formed on the blade shell 10, the C-shaped cavity 26 is preferably filled with polymer 66 in a single shot. As such, the leading edge protection shield 20 formed on the blade shell 10 preferably comprises a single layer of polymer 66. Forming a single-layer leading edge protection shield 20 negates any risk of separate layers delaminating in use, thereby resulting in a more durable protection shield 20. Advantageously, the method and mould 22 in examples of the present invention provide a single-shot manufacturing process wherein contact with, or exposure of, any uncured adhesives or polymers is minimised, thereby minimising the risk of contamination in the bond between the protection shield 20 and the blade shell 10.

In some examples, the polymer 66 may be self-setting and may cure without any further external catalyst. For example, the polymer 66 may be a molten polymer which solidifies in the C-shaped cavity 26 after cooling. In such examples the polymer 66 may cool naturally or in some cases the mould 22 may comprise cooling apparatus (not shown) configured to extract heat from the polymer 66 in the C-shaped cavity 26. A suitable polymer 66 for forming the leading edge protection shield 20 may be polyurethane for example.

The polymer 66 in some examples may comprise a chemical catalyst to expedite the curing or setting of the polymer 66 in the C-shaped cavity 26. For example, the polymer 66 may comprise two-component resin such as a two-component epoxy based resin or a polyurethane based resin, which is pre-mixed i.e. supplied to the cavity 26 as a mixture. In some examples the curing process may be further aided by applying heat to the polymer 66 in the mould cavity 26. In such examples the mould 22 may comprise heating apparatus (not shown) configured to supply heat to the polymer 66 in the cavity 26, by heating the mould surface 24 for example, to expedite the curing of the polymer 66. Insulation of the mould (not shown) was also found to be provided to reduce energy consumption and/or thermal stability during curing.

The mould 22 and method of forming the leading edge protection shield 20 on the blade shell 10 in accordance with examples of the present invention advantageously only requires preparation of a single surface or interface for forming the protection shield 20 on the blade shell 10. For example, compared to add-on devices 110 of the prior art which require preparation of both the blade shell 10 and an interior connection surface of the add-on device 110, the method described herein can be used to form a leading edge protection shield 20 without first preparing a surface of the shield. The single bond interface involved in this method further reduces the risk of contamination or other defects such as dry spots or air bubbles that may be detrimental to the longevity of prior art leading edge protection methods through delamination or other defects. Further, the blade shell 10 itself is, in effect, a second mould surface in the above described method, and forming the protection shield 20 directly on the blade shell 10 ensures that the protection shield 20 has exactly the correct shape to fit perfectly on the blade shell 10 and hence prevent tension in the shell creating cavities in the adhesive layer during adhesion of preformed shells to a blade.

As shown in FIG. 5b, a leading edge protection shield 20 formed on a blade shell 10 in accordance with examples of the present invention comprises an aerodynamic profile which transitions smoothly to the windward and leeward surfaces 12, 14 of the blade shell 10. In particular, the tangential arrangement of the mould surface 24 with the windward and leeward surfaces 12, 14 of the blade shell 10 at the windward and leeward edges 32, 34 of the cavity 26 facilitates the elimination of any step between the surface 28 of the shield 20 and the blade shell 10, or at least minimises any such step to an aerodynamically insignificant step height. As such, the mould 22 and method for forming the leading edge protection shield 20 as described herein facilitates the protection of the leading edge 16 of at least a portion of a wind turbine blade shell 10, without adversely affecting the aerodynamic performance of the wind turbine blade.

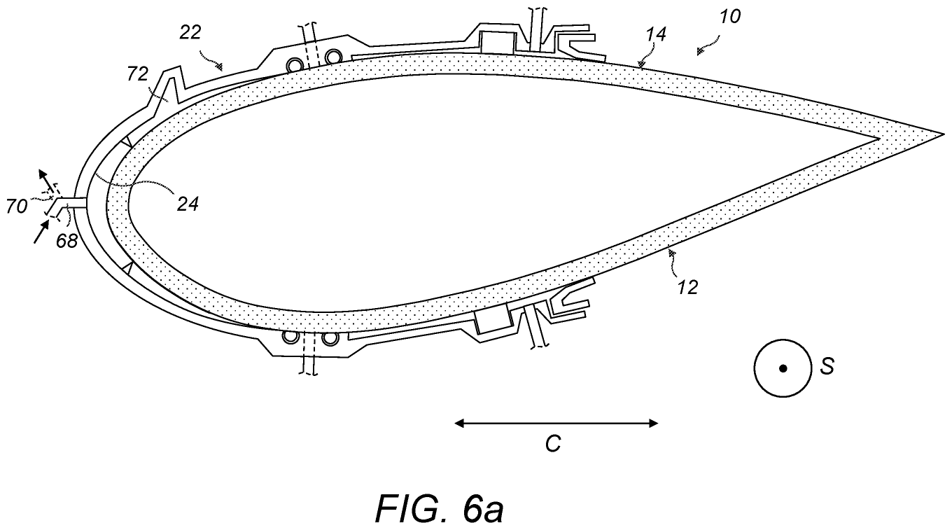

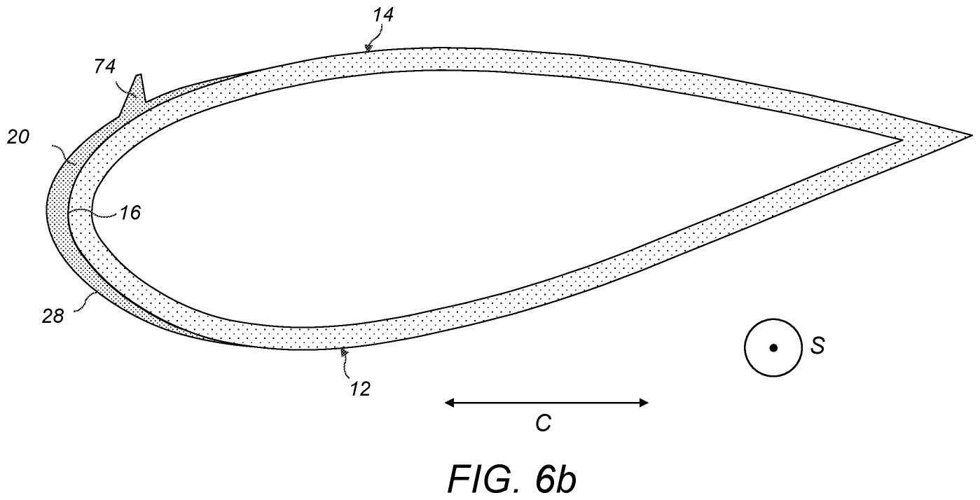

A further example of a mould 22 and a blade shell 10 with a leading edge protection shield 20 formed thereon is shown in FIGS. 6a and 6b. In some examples the mould surface 24 may comprise one or more recesses 72 configured to integrally form aerodynamic elements 74 that extend from the outer surface 28 of the leading edge protection shield 20. For example, the recesses 72 may be configured to form one or more vortex generators 74 with the leading edge protection shield 20. Forming aerodynamic elements 74 integrally with a leading edge protection shield 20 may advantageously increase the longevity of such elements 74 by reducing the risk of such elements detaching from the blade shell 10. In particular, the surface area of the leading edge protection shield 20 in contact with the blade shell 10 may be significantly greater than the contact area available for individually attaching aerodynamic elements to the blade shell 10, thus improving the resilience of the connection of the elements 74 to the blade shell 10.

In some examples the mould surface 24 may be substantially rigid throughout, and the method may not comprise evacuating the second sealed volume to bring the mould surface 24 into tangential alignment with the windward and leeward surfaces 12, 14 of the blade shell 10. Instead, the mould surface 24 may be brought into tangential alignment with the windward and leeward surfaces 12, 14 by arranging the mould 22 with the blade shell 10, and/or by pressing the mould surface 24 up to and against the surfaces 12, 14 of the blade shell 10. However, as previously described, in preferred examples, at least a portion of the mould surface 24 is substantially flexible to allow the mould surface 24 to be brought into tangential alignment with the blade shell 10 by evacuating the second sealed volume. In yet other examples, substantially the entire mould surface 24 may be flexible. For example, the mould surface 24 may be provided as a substantially flexible planar sheet which is wrapped around the leading edge 16 of the blade shell 10 to define the C-shaped cavity 26. Such a configuration may be advantageous for repairing damaged wind turbine blades with a blade shell 10 having non-uniform geometry at the leading edge 16.

In some examples, the mould 22 may not comprise a seal carrier 56. The seal retaining channels 58 may be provided in the mould 22 instead. Such an example reduces the number of separate parts of the mould 22.

It will be appreciated that features described in relation to the various examples above may be readily combined with features described with reference to different examples without departing from the scope of the invention as defined in the appended claims.

Further, it will be appreciated that the above description and accompanying figures are provided merely as an example. Many alternatives to the specific modular blade and method described above are therefore possible without departing from the scope of the invention as defined in the appended claims.

1. A method of forming a leading edge protection shield on a wind turbine blade shell, the method comprising:
providing at least a portion of a wind turbine blade shell comprising a windward surface, a leeward surface, and a leading edge;
providing a leading edge mould comprising a concave curved mould surface;
arranging the mould over the leading edge of the blade shell such that a generally C-shaped cavity is defined between the blade shell and the mould surface;
clamping the mould to the windward surface and/or to the leeward surface of the blade shell using a clamping arrangement spaced from the leading edge in a chordwise direction;
providing an edge sealing arrangement positioned between the leading edge and the clamping arrangement in the chordwise direction;
forming a seal between the mould surface and the windward and leeward surfaces of the blade shell using the edge sealing arrangement to define windward and leeward edges of the C-shaped cavity, wherein the mould surface is substantially tangential to the windward and leeward surfaces at the windward and leeward edges such that the C-shaped cavity tapers in thickness towards the windward and leeward edges of the C-shaped cavity; and
supplying polymer to the C-shaped cavity to form a leading edge protection shield on the blade shell.

2. The method of claim 1, wherein the clamping arrangement comprises a first sealed volume defined between the mould and the windward and/or leeward surfaces of the blade shell, and wherein the step of clamping the mould to the windward surface and/or the leeward surface comprises evacuating the first sealed volume.

3. The method of claim 1, wherein the edge sealing arrangement comprises a second sealed volume defined between the mould and the windward and leeward surfaces of the blade shell, and the method further comprises evacuating the second sealed volume.

4. The method of claim 3, wherein evacuating the second sealed volume causes the mould surface to the move into tangential alignment with the windward and leeward surfaces at the windward and leeward edges of the C-shaped cavity.

5. The method of claim 1 further comprising supplying the polymer to the C-shaped cavity under positive pressure.

6. The method of claim 1, wherein the mould comprises a plurality of spacing protrusions extending inwardly from the mould surface, and wherein the spacing protrusions engage the blade shell to define a thickness of the C-shaped cavity.

7. The method of claim 1 wherein the method comprises filling the C-shaped cavity with polymer in a single shot to form the leading edge protection shield as a single layer of polymer on the blade shell.

8. A mould for forming a leading edge protection shield on a wind turbine blade shell, the mould comprising:
a concave curved mould surface for arranging over a leading edge of a blade shell to define a substantially C-shaped cavity;
a clamping arrangement for clamping the mould to a windward surface and/or a leeward surface of the blade shell; and
an edge sealing arrangement located between the mould surface and the clamping arrangement, the edge sealing arrangement being configured for sealing the mould surface to the blade shell at windward and leeward edges of the C-shaped cavity such that the C-shaped cavity tapers in thickness towards said windward and leeward edges.

9. The mould of claim 8, wherein the clamping arrangement comprises a vacuum clamp having a pair of mutually spaced first seals configured to seal against the windward and/or leeward surface of the blade shell to define a first sealed volume, and a first vacuum outlet for withdrawing air from the first sealed volume.

10. The mould of claim 8, wherein the edge sealing arrangement comprises a pair of mutually spaced second seals configured to seal against the windward and leeward surface of the blade shell to define a second sealed volume, and a second vacuum outlet for withdrawing air from the second sealed volume.

11. The mould of claim 10, wherein the second seals are compressible.

12. The mould of claim 11, wherein the edge sealing arrangement further comprises a seal carrier that retains the second seals, the second seals protruding from the seal carrier when uncompressed, and being substantially fully contained within the seal carrier when compressed.

13. The mould of claim 8, wherein the mould is flexible such that it may conform to the shape of the blade shell.

14. The mould of claim 8 further comprising a substantially rigid central portion of the mould surface configured for arrangement with the leading edge of the blade shell.

15. The mould of claim 8, further comprising one or more air outlets in fluid communication with the C-shaped cavity.

16. (canceled)

17. The method of claim 1, wherein the method comprises removing air from the C-shaped cavity via one or more air outlets in fluid communication with the C-shaped cavity.

18. A mould configured to form a leading edge protection shield on a wind turbine blade shell comprising a windward surface, a leeward surface, and a leading edge; the mould comprising:
a concave curved mould surface for arranging over the leading edge of the blade shell to define a substantially C-shaped cavity between the blade shell and the mould surface;
a clamping arrangement spaced from the leading edge in a chordwise direction and for clamping the mould to a windward surface and/or a leeward surface of the blade shell;
an edge sealing arrangement located between the mould surface and the clamping arrangement, the edge sealing arrangement being configured for sealing the mould surface to the blade shell at windward and leeward edges of the C-shaped cavity such that the C-shaped cavity tapers in thickness towards said windward and leeward edges; and
a polymer at least partially filling the C-shaped cavity.
